(19) United States
(12) Patent Application Publication
(10) Pub. No.: US 2012/0089466 A1
(43) Pub. Date: Apr. 12, 2012

(54) Ranking and display of stackable mobile banner ads

(76) Inventor: Walt Froloff, Aptos, CA (US)

(21) Appl. No.: 13/068,146

(22) Filed: May 2, 2011

Related U.S. Application Data
(63) Continuation of application No. 12/924,839, filed on Oct. 6, 2010.

(51) Int. Cl. G06Q 30/00

(52) U.S. Cl. 705/14.71; 705/14.4

(57) ABSTRACT

A mobile device capable of receiving groups of ads for displaying, storing, and retrieving and from a mobile app, providing the app user to interactively navigate through, store, retrieve, view and select a received set of stackable banner ads in mobile apps.

### BACKGROUND

### Field of the Invention

The present invention generally relates to mobile device advertisements and more specifically, to banner ads on mobile devices.

In mobile advertising markets, mobile ads are most commonly seen as a Mobile Web Banner, top of page banner, or Mobile Web Poster, bottom of page banner. Other mobile ads spaces are dominated by SMS advertising. SMS or texting is the most widely used data application in the world, with 2.4 billion active users. Other forms of mobile ads include MMS advertising. Multimedia Messaging Service, is a standard way to send messages that include multimedia content to and from mobile phones. It extends the core SMS capability which only allowed exchange of text messages up to 160 characters in length. The mobile ad business models today are mainly statistical where only a small fraction find are timely and locally delivered, finding motivated customers. What is needed are more targeted mobile ad approaches, where the ads are informing “motivated customers” of a way to resolved a present need in real-time.

When the mobile ad has a low click through rate, it is due to the lack of ad persuasion for any number of reasons. Perhaps the mobile ad fails to be informative, timely or of interest. Most current mobile ads fail in this mission because the ad is not timely, not convenient or the potential consumer is not motivated at the ad display time. Local searches have been identified as on the rise since mobiles have come into wide spread use. What is needed is higher percentage of click-through rates, of mobile ads that reach consumers just in time to act on the ad, when they are motivated, when they are proximate to fulfillment and at the time that the ad becomes of notice to the consumer.

A problem with traditional approaches to advertising is the fixed use of available device display space. Technology has allowed that advertising real-estate can be programmatically changed, but when to change the ads at the most opportune time for maximum ad revenue is an art wrapped in mystery. Mobile technology has not been exploited to this end but desperately needs solutions because mobile display real-estate is very small and very valuable. What is needed are ways to use, or more optimally reuse, the mobile display area to provide more, less random and intelligent ad opportunities.

Click-through rates can be increased by ad choices and options. While one mobile ad is not persuasive for whatever reason, two or more will offer choices to the user which increase the likelihood that one of the choices will see a click through. What is need are banner ads that provide choices and options to consumers, choices and options that make sense to the consumer.

An advertising network like Google Admob or Apple iAds, with many advertisers and an opportunity to advertise with many mobile ad clients is beset with a challenge; which advertiser earns the mobile display region in competition with other advertiser clients for the same region, and which advertiser gets the banner ad placement. Many mobile advertisers send enormous numbers of mobile ads regardless of consumer needs or even advertiser economics, simply because the mobile technology allows them to do so. What is needed are ways to segment advertising zones among advertisers. According to Google, ⅓ of all mobile searches currently indicate a local intent. As more consumers look to fulfill locally, less advertisers will wish to advertise outside of their fulfillment zone. Location Based Service, LBS, models allow for some of these but they are not mature and most are still web-centric, not fully exploiting the smart mobile technology. This makes those models less consumer relevant, relying on demographics and not personal needs. What is needed are ways of segmenting markets by vendor zones, so that advertisers can more accurately select and target their advertising zones depending on consumer mobility and mobile consumer location as well as their own more fixed or less mobile product-service location. Current LBS models generally allow for either a variable mobile consumer location or the vendor location, one but not the other. Thus what is needed are advertiser selections of individual advertiser advertisement zones customized to the advertisers servicing only particular and selectable physical regions.

What is needed is of intelligent ranking of advertisers in the mobile display space such that mobile users can receive more than one advertisement for a set of local advertisers in accordance with a maximum ad revenue for the ad publisher. What is needed is more intelligent and less random ad placement.

### SUMMARY

The present invention discloses a system and method for display of stackable banner ads in mobile devices. The system provide user storable, user retrievable and user selectable ads for display on a mobile device. The components include a mobile device with operatively connected display screen, at least one wireless connection protocol at least one channel open to an ad server, at least one registered and downloaded mobile app, a device resident software environment providing display services and user specific display area controls, and a plurality of ads received from the ad server. This allows the ads received from the ad server to be displayed in a pre-set ad display area through interactive app user's use of mobile banner ad display controls.

### BRIEF DESCRIPTION OF DRAWINGS

Specific embodiments of the invention will be described in detail with reference to the following figures.

FIG. 1 shows a block diagram showing the hardware components of the wireless client device in accordance with an embodiment of the invention.

FIG. 2 is a smart wireless device with environment for mobile applications, apps, and operating system internal architecture in accordance with an embodiment of the invention.

FIG. 3 is illustrates a typical mobile app different uses of banner ad space in accordance with an embodiment of the invention.

FIG. 4 is a graphical depiction of software structure for processing, storing, displaying and using banner ad space according to an embodiment of the present invention.

FIG. 5 is an illustration of mobile ad advertiser zone management and ranking of mobile app banner ad display within-zone intersections according to an embodiment of the present invention.

FIG. 6 is an illustration of typical mobile apps used for stackable banner ads according to an embodiment of the present invention.

FIG. 7 is an illustration of 3D stackable banner ads according to an embodiment of the present invention.

FIG. 8 is an illustration of stackable banner ads in a feature phone displaying SMS ad messages according to an embodiment of the present invention.

### DETAILED DESCRIPTION

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

A preferred embodiment of the invention is a stackable banner ad the allows an mobile app user executing an app to receive multiple ads that can be navigated by controls provided for the banner ad display area. This control in the banner ad display area also provides a mechanism to receive groups of prioritized or ranked array of banner ads which can be accessed interactively.

### OBJECTS AND ADVANTAGES

The present invention discloses a system for displaying multiple mobile banner ads simultaneously in an ranked order.

Accordingly, it is an object of the present invention to provide choices of banner ads in a mechanism by which a user can view many ads in a reusable display space on demand.

It is another object of the present invention to provide embodiments designed display of stackable manners complete with controls to step through the ranked or ordered ads.

It is yet another object of the invention to couple the mobile ad display of multiple banner ads with a revenue enhancing ad ranking order array of received ads.

### Embodiments of the Invention

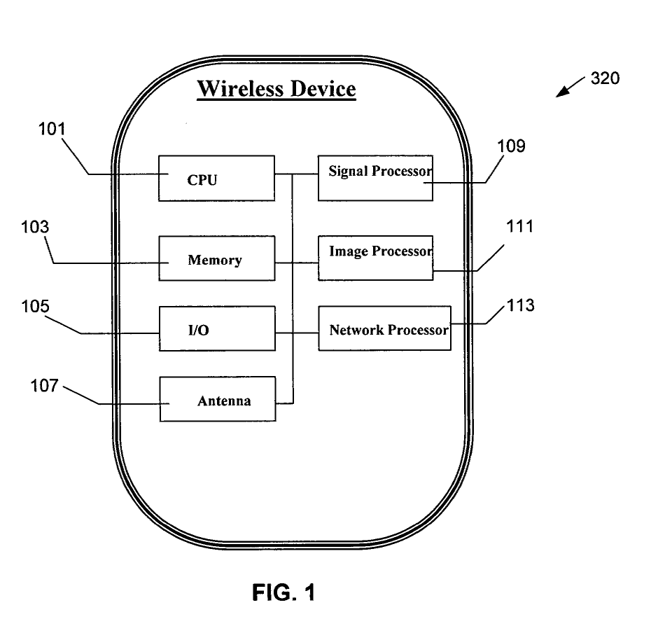

FIG. 1 shows a block diagram showing the hardware components of the wireless client device in accordance with an embodiment of the invention.

The invention may be implemented on virtually any type of wireless device regardless of the platform being used providing the performance, storage and bandwidth requirements are sufficient. For example, as shown in FIG. 1, wireless device 120 includes a processor CPU 101, associated memory 103, a I/O processor/bus 105, network adaptor 113, Digital Signal Processor(s) 109, antenna 107 and associated circuitry and numerous other elements and functionalities typical of today's smartphones (not shown). The wireless device 120 may also include input means, such as a keyboard, not shown, and a light pencil, not shown, and output means, such as display, The wireless device 120 must be network connectable to a local area network (LAN) or a wide area network (e.g., the Internet) (not shown) via a network interface 113. Those skilled in the art will appreciate that these input and output means may take other forms.

The I/O processor/bus 105 can service many devices and sensors including but not limited to sensors such as 3D accelerometers, gyroscopes, touch screen, motion sensors, light sensors, proximity sensors, wireless communication, audio subsystem, camera, video, ultrasonic sensor, and others. These devices and sensors are all sources of primary information for mobile app activities to be used in embodiments of the invention.

Further, those skilled in the art will appreciate that one or more elements of the aforementioned wireless device 120 may be located at a remote location and connected to the other elements over a network. Further, software instructions to perform embodiments of the invention may be stored on the device computer readable medium such as a compact disc (CD), a memory stick, a file, or any other computer readable storage device in communication with the wireless client.

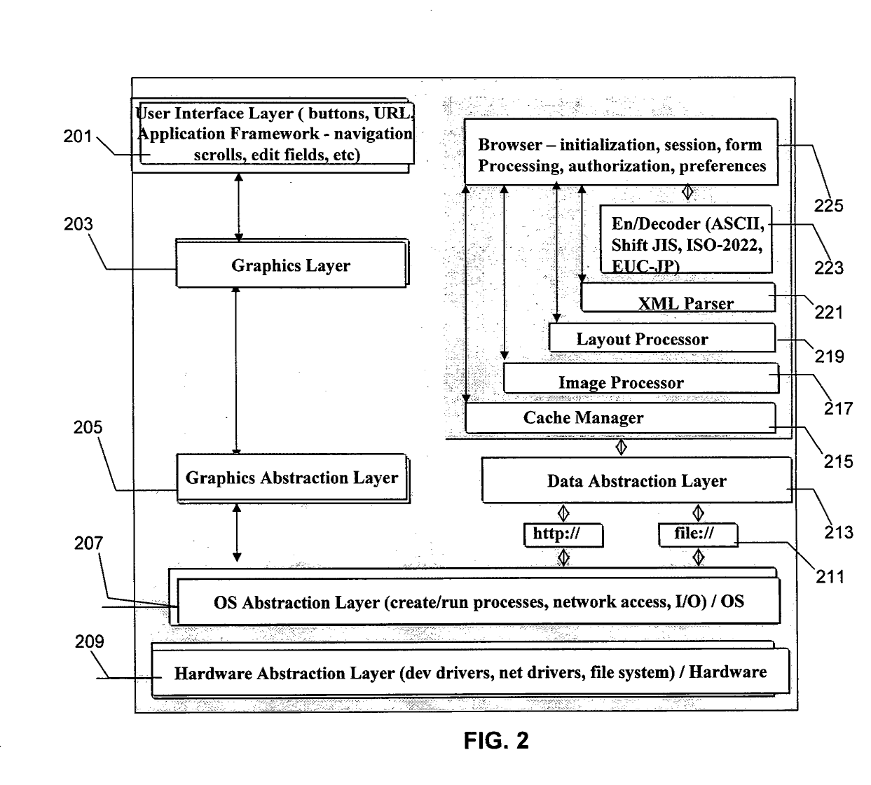

FIG. 2 is a smart wireless device with environment for mobile applications, AKA apps, and operating system internal architecture in accordance with an embodiment of the invention.

The User Interface (UI) layer 201 supports buttons, key pads, touch screen and other I/O, URLs navigation, an application framework for scroll bars, edit fields, text areas, etc. The graphics layer 203 comprises encoder/decoder 223, XML parser 221, Layout processor 219, Image processor 217 and cache manager 215. These all support event managers, window manager, graphical primitives, display manager for supporting the browser 225 functions. These software entities are all configurable in many memory footprints. The graphics abstraction layer 205 interfaces with the wireless device Operating System 207 (OS) for process creation, network access, I/O and other OS functions. The data abstraction layer 213 interfaces the http and file calls and protocols to the OS 207 layer which ultimately directs the hardware 209 to physically carry out the I/O and internal device functions.

FIG. 2 also shows a wireless device internals architecture supporting a UI with a menu and keypad. In an embodiment of the invention, the menu supports a browser menu environment. Many mobile browsers are highly customizable allowing the addition of many interface languages within a multilingual environment. The interface design has editable menus and customizable user roles and file upload types which can support embodiments of the invention and are known to those skilled in the art.

In another embodiment, the browser is pre-configured to allow startup by using it directly after completing the set-up process. The user interface and support function environment provides adding different file types, adding menus and changing the look and feel of the installation. The look and feel and general menus are configured once by vendor but can be altered in different versions and products. Hence, app user controls are provided to interface with app execution for input regarding defined functions operating on specific mobile display screen area showing ads.

A lockdown of the browser or applications can be implemented in some embodiments to increase security or customize the device to prevent unknown interferences or enable quicker response through un-encrypted or lightly encrypted communication.

The remote client browser then is coupled, by programming it, to support chosen standard communication protocols or proprietary protocols to connect the client to the local content servers, giving access to local metadata cache, relevant to a particular application from ?????server's profile views. In a preferred embodiment, the communication protocol stack may include ASP.NET Applications, (Qcommon Application), Cassini (or other pluggable protocol), Qcommon Framework (BoMgr, etc), Common Data Services Access (CDSA) and SQL Everywhere on the user end.

The mobile Operating System, OS, man include but is not limited to Apple's iOS, Android, Linux, MS Windows, CE, Symbian, RIM, Java, and others environments supporting SMS.

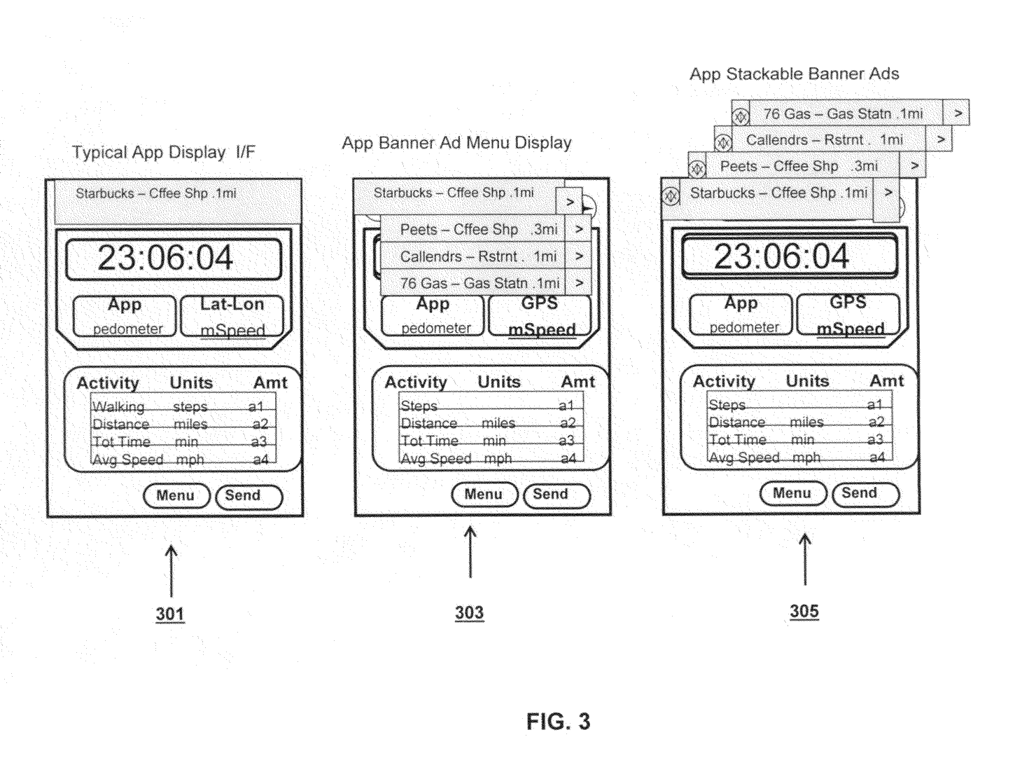

FIG. 3 is illustrates a typical mobile app with different uses of banner ad space in accordance with an embodiment of the invention.

301 depicts the typical app with a typical one banner ad just below the upper display screen boundary. An embodiment of the invention provides a mobile ad display 303 with user controls for a menu driven banner ad display with banner ads as submenu items. Thus the submenu can be rolled up or down as shown, to display lower ranked ads delivered in a group. The embodiment shown in 305 illustrates the banner display area in a mobile display with representations of stacked banner ads behind the displayed banner ad. Controls for navigating through consecutively stacked ad from the group of ads at user selection are shown on the left and right hand sides of the banner display area.

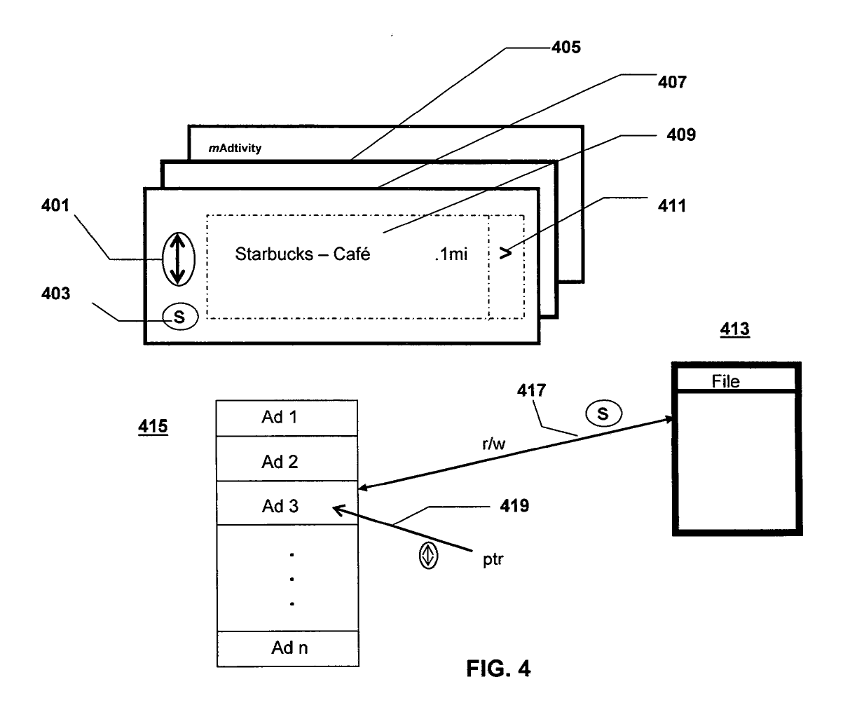

FIG. 4 is a graphical depiction of software structure for processing, storing, displaying and navigating the banner ad space according to an embodiment of the present invention. A banner ad will have a limited area 409 for an advertisers contact label and a click through control 411 which will navigate the user to the advertisers preferred contact method. The banner frame 409 407 can vary in thickness, color, feature, movement or other mechanism to alert app user the ad options have arrived. A small scroll bar positioned on the banner space left hand side 401 allows the app user an interactive control, pointing 419 to the ad of interest in the array 415 of received ads. This provides an app user interactive navigation through the array of ads to display the user's preferred ad. This mechanism increases the changes of click through because the user has more chances and choices to click through. The probability of click through on at least one of the ads just became the sum of the probability of a click through and all of the ads. A “save” button 403 is a control shown on the banner ad left hand side allowing the user to store 417 the currently displayed banner ad to a file 413 for later retrieval. The file 413 can be local or globally stored. This click through rates can be increase by deferred click through, and may have a different cost. Another control, not shown, is whether the advertiser is offering a coupon at that time. User may choose the advertiser with the best pending deal. Upon tapping the coupon control, that information is revealed to the user.

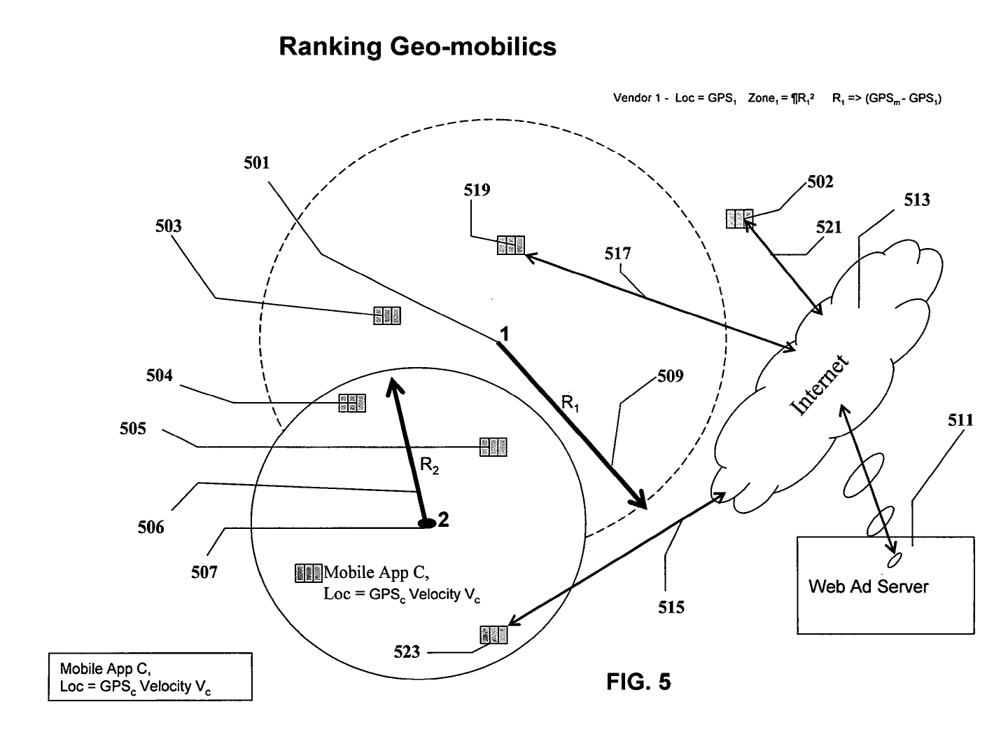

FIG. 5 is an illustration of mobile ad advertiser zone management and ranking of mobile app banner ad display in zone intersections according to an embodiment of the present invention. Service providers that serve a local market may elect to advertise in a zone surrounding their establishment. Zones can be any shape. An aspect of the invention provides advertisers with functionality to select the area of their advertising zone and include many variables and characteristics of the mobiles within that zone which are advertiser viable for ads. In some embodiments mobile app activity will be a primary factor in predicting click through rates for advertisers. Mobile app activities can include such things as the name of the app, category and or subcategory of app, sensor data, average velocity of mobile, time of day, type of day, calendar day, duration of app use, frequency of use and more.

However, two advertiser zones centered at advertiser selected locations 501 502 in disk shape zones subtending zones 1 501 and 2 5-7 respectively are shown with some zone overlap. In an embodiment of the invention the advertiser zones are defined location centers with radii R1 509 and R2 506 circle enclosed areas 1 and 2 of zone 1 501 and zone 2 507 respectively. A mobile 503 located in zone 1 501 is wholly within only zone 1 but some mobiles 504 505 are located in the intersection of both zone 1 501 and zone 2 507. While another mobile 502 is located wholly outside of zone 1 and zone 2. Where the mobiles are in a single zone, the advertiser will have a factored advantage by virtue of being the only local advertiser which is proximate to the user and where a transaction more likely than if all the advertisers had competing ads where competing advertiser are not proximate but still wish to have mobile ads published. If an advertisers must bid for the ad space at auction, in such cases with only one bidder, the bid price may then default to a set minimum, if indeed an ad is published to the mobile on advertisers behalf. However, in most cases a ranked order will factor the zone proximate mobiles and ad receiving mobiles will have app banner ads published and stacked in some ranked order. The ranking order is used in display stacking with potentially highest banner ad revenue ads foremost in the mobile app banner display area and the least potential ad revenue ads are farthest in the banner ad display order.

Where mobiles 504 505 in the intersecting zones are candidates for both advertisers banner ads, the ads can be can be ranked to generate maximum revenue to the ad publisher. Where the mobile's location 502 is outside all locally defined zones, but still a non-local advertiser wish to send ads, this advertiser will not get the local factor expected click through factor bump. This does not mean the outsider cannot achieve a higher ranking overall because other factors will affect the ranking order. However, the local proximate mobile vendor-advertiser stands a high likelihood of higher ranking if immediate mobile user needs are deemed physical in nature, that is their need or requirement will not be delayed by shipping or long distance time delay.

Maximum ad revenue is realized when the ad price multiplied by the mobile users click through rates are maximum. However, the click through rate is different for each advertiser-mobile transaction and not known apriori. The click through rate therefore must be estimated to determine the optimal ranking order. Although past click through rates can and are used, factors considered in estimating that a click through will occur are probabilistic at best and hence a more Bayesian approach is warranted in obtaining good probabilities of click through rates for different advertisers with unique mobile users. Thus some embodiments of the invention will assign numbers to factors in specific instances to advertiser and mobile data to estimate probabilities of click through rates.

Thus the ranking order for mobiles in the intersection will bump factors for rankings in both mobiles 504 505 in the zone intersection over non zone proximate advertisers not from zone 1 501 or zone 2 507. The ranking order is calculated to maximize advertising revenue based on factors from a set of factors comprising advertiser selectable ad local zone area and location proximity, number of participating mobiles in the advertisers zone, number of network connected mobile devices in another advertisers intersecting zone area, bid price for ad, mobile app activity relative to the advertisers product or service, media reported events reasonably expected to affect a mobile banner ad's click through by the app user, and advertisers previous click through rate for a similar ad.

Thus the bid price times the calculated or determined click through rate will generally yield the highest ad revenue to the publisher. In an embodiment of the invention the calculated or determined mobile user click through rate, publisher ranking engine seeks to use not only the advertisers past click through rate but one based on current events which can promote or demote chances for click through. For example a financial app ready and available to receive an ad from a financial institution advertiser will have a click through estimate external event factor promotion or demotion for the events factor, where media events favor or disfavor the ads potential for click through respectively, by app user.

In formulaic terms this amounts to:
R=Revenue
P=Price Bid
M=number of mobiles in zone
LZ=advertiser selectable ad local zone area
LP=local proximity,
N=number of network connected mobile devices also in intersecting zone area
AA=App activity(ies) relative to the advertisers product-service
E=media reported events
CR=estimated Clickthrough rate=f (M, LZ, LP, N, AA, E)

Mobile wireless network standards and protocols vary and embodiments of the invention can use most any wireless standard implemented with mobiles including but not limited to 802.11a, 802.11b, 802.11g, and 802.11n. The wireless connections 521 517 515 between the mobiles 502 519 523 and the Internet cloud 513 link the mobiles to a web ad server 511 which serves up the mobile app banner ads in groups of one or more advertiser's ads to the mobile. Thus in an embodiment of the invention at least one wireless connection protocol with at least one channel open to an ad server communicates with the mobile and specifically at least one registered and downloaded mobile app. The mobile OS provides device resident software environment with local display services. An aspect of the invention provides registered app specific on screen display area controls for manipulating ads on individual user mobile apps.

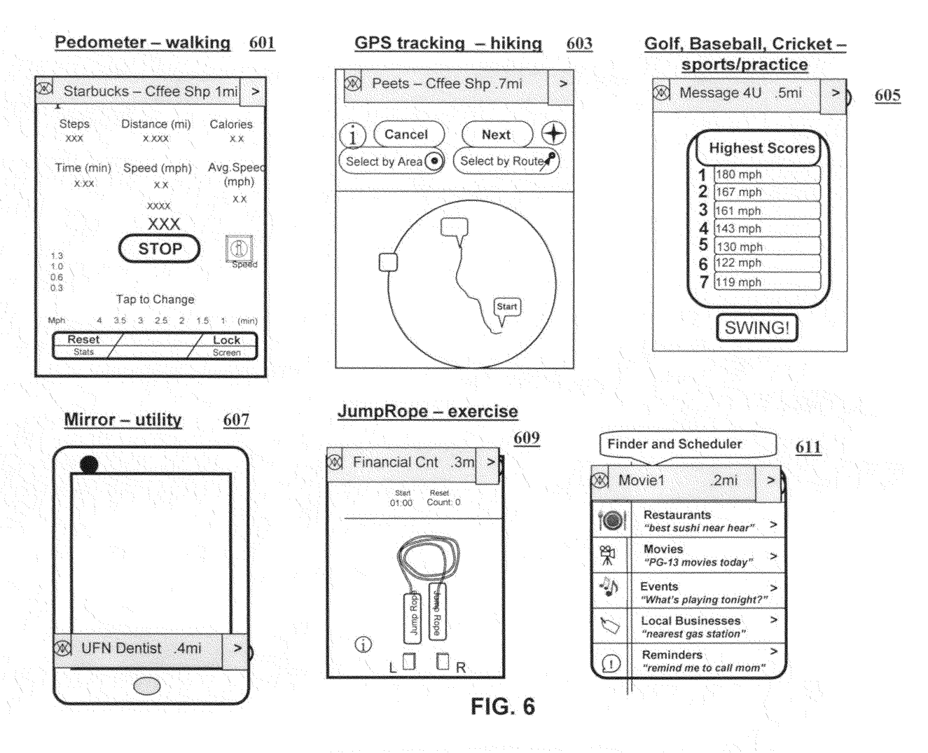

FIG. 6 is an illustration of typical mobile apps used for stackable banner ads according to an embodiment of the present invention. Apps 601 603 605 607 609 611 are typical of hundreds of thousands of types of apps and represent millions of downloaded registered and instantiated apps executing on mobiles. Aspects of the invention require that an Jar file or comparable archived library be contained and integrated by the app developer, using the SDK supplied to the app developer, to register the app with the invention ad web server for mobile app communication of mobile speed, location, app name, unique hashed and or encrypted ID, and sensor data and or other mobile specifics. In some embodiments of the invention, user app data is received at app registration time and stored in the model ad server in the cloud, for run-time mobile app use. This becomes advertiser searchable data and be available to the advertisers to increase their chances of targeting users with higher click through factors.

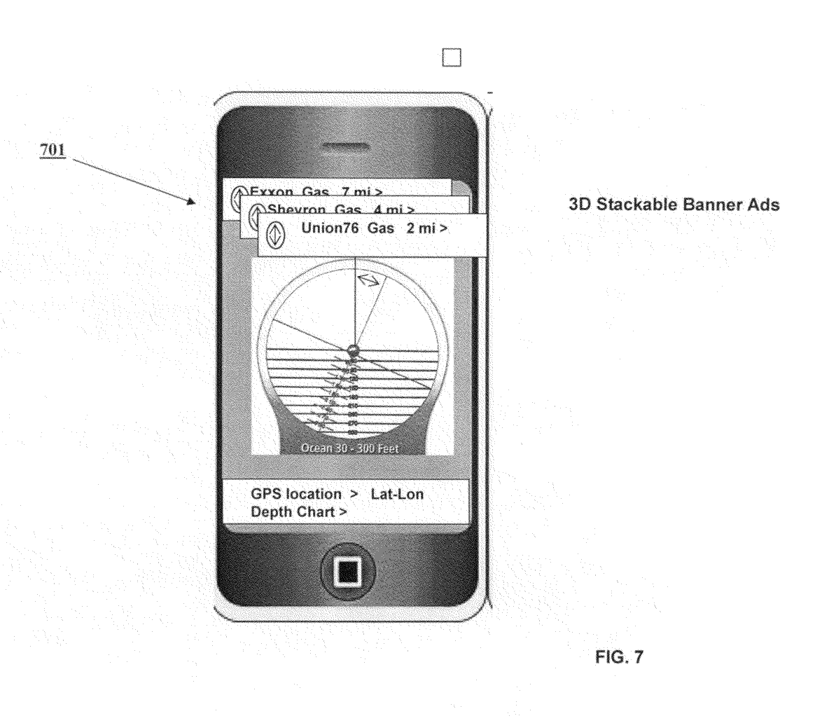

FIG. 7 is an illustration of 3D stackable banner ads according to an embodiment of the present invention. The 3D perspective view by successive back banner ad frame perspective or actual 3D banner frame stacks representing an array of banner ads is shown. Such a display rendering provides the app user with a visual reminder that there are alternate banner ads that may be pertinent to them. It stands to reason that as advertisers get better at targeting app users, user curiosity will be motivated to depend more on the group of ads for relevant proximate goods and services and thereby produce higher click through rates.

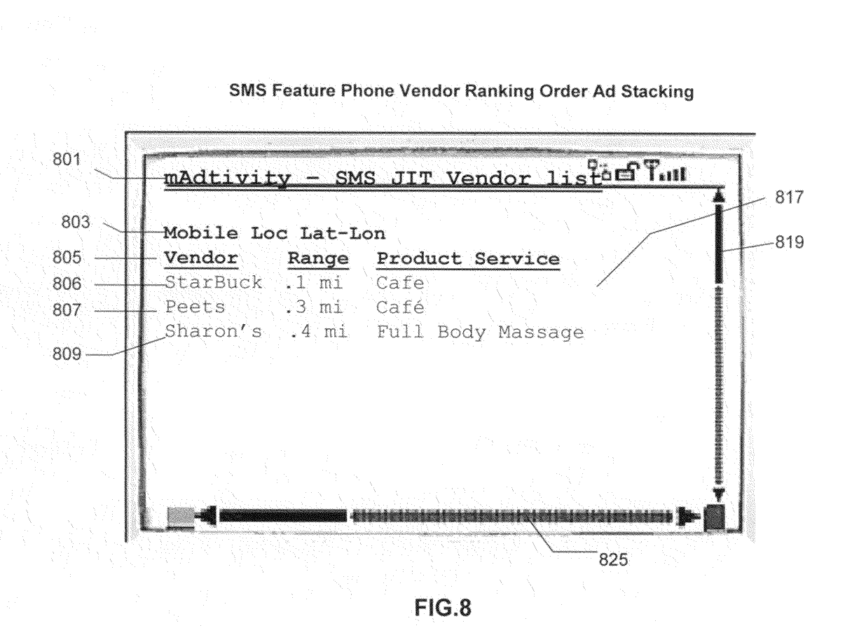

FIG. 8 is an illustration of stackable banner ads in a feature phone displaying SMS ad messages according to an embodiment of the present invention. A typical texting app 817 will provide some user controls like scrolling 819 825 in contrast and inferior to the typical smart phone OS capabilities and functions, but yet still ad stack implementable. In SMS texting environments an ad stacking order takes on the character look and feel of the host texting environment provided. In an embodiment of the invention the Ad Publisher 801 may have top billing and some location data 803 may be presented followed by a ranked advertiser 805 list 806 807 809 and pertinent product-service and contact details which can be selected by the user.

Therefore, while the invention has been described with respect to a limited number of embodiments, those skilled in the art, having benefit of this invention, will appreciate that other embodiments can be devised which do not depart from the scope of the invention as disclosed herein. Other aspects of the invention will be apparent from the following description and the appended claims.

What is claimed is:

1. A system for mobile user with on demand storable, retrievable and selectable banner ads for display on a mobile device from a group of received ads comprising:
a mobile device with operatively connected display screen,
at least one wireless connection protocol at least one channel open to an ad server,
at least one registered and downloaded mobile app,
a device resident software environment providing display services and user specific on screen display area controls for manipulating ads, and
a plurality of ads received from the ad server
whereby the ads received from the ad server can be displayed interactively by the app user in a pre-set ad display area by the app users use of ad display controls in the ad display area.

2. The mobile ad display system as in claim 1 further comprising groups of ads received from the server in a ranked order for display at app users election.

3. The mobile ad display system as in claim 2 further comprising groups of ads ranked to maximize advertising revenue based on factors from a set of factors consisting essentially of advertiser selectable ad zone area and location, number of participating mobiles in the advertisers zone, number of network connected mobile devices in another advertisers intersecting zone area, bid price for ad, mobile app activity relative to the advertisers product or service, news media reported events reasonably expected to affect an ad's click through and advertisers previous click through rate for similar ad.

4. The mobile ad display system as in claim 2 further comprising ad server with Internet auction engine receiving bids on ads to be sent to participating mobile apps.

5. The mobile ad display system as in claim 1 further comprising user controls for navigating through consecutively stacked ad from the group of ads at user selection.

6. The mobile ad display system as in claim 1 further comprising user controls for storing the mobile ad for app user retrieval and display on demand.

7. The mobile ad display system as in claim 1 wherein the banner ads appear stacked by frame in a 3D perspective rendering.

8. The mobile ad display system as in claim 1 wherein the banner ads appear stacked by frame in a 3D rendering.

9. The mobile ad display system as in claim 1 further comprising user controls for a menu driven banner ad display with banner ads as submenu items.

10. A computer implemented method for storing, retrieving and selecting mobile app banner ads on a mobile device further comprising the steps of:
having a mobile device with operatively connected display screen and at least one wireless connection protocol,
device providing a resident software environment with programmable display services and user specific display area controls,
registering at least one app with the ad service,
downloading at least one mobile app,
opening at least one channel of the wireless protocol to an ad server, and
receiving a plurality of ads from the ad server
whereby the ads received from the ad server can be displayed in a pre-set mobile app ad display area through the app users use of mobile display controls in the app during execution.

11. The method for storing, retrieving and selecting mobile app ads in claim 10 further comprising the steps of receiving groups of ads from the ad server in a ranked order for display at app users election from that order.

12. The method for storing, retrieving and selecting mobile app ads in claim 11 further comprising the steps of receiving groups of ads ranked to maximize advertising revenue based on factors from a set of factors consisting essentially of advertiser selectable ad zone area and location, number of participating mobiles in the advertisers zone, number of network connected mobile devices in another advertisers intersecting zone area, bid price for ad, app activity relative to the advertisers product or service, media reported events reasonably expected to affect an ad's clickthrough by the app user, advertisers previous click through rate for similar ad.

13. The method for storing, retrieving and selecting mobile app ads in claim 10 further comprising the steps of receiving groups of ads from an ad server with internet auction engine receiving bids on ads to be sent to mobile apps.

14. The method for storing, retrieving and selecting mobile app ads in claim 10 further comprising the steps of providing user controls in the app display screen for navigating through the group of received ads for purposes of displaying selected ad by app user.

15. The method for storing, retrieving and selecting mobile app ads in claim 10 further comprising the steps of providing user controls for storing and retrieving the mobile ad for app user display on demand.

16. The method for storing, retrieving and selecting mobile app ads in claim 10 further comprising the steps of providing controls for navigating through the group of ads in the banner display area for display of user elected ad.

17. The method for storing, retrieving and selecting mobile app ads in claim 10 further comprising the steps of providing user controls in the ad area for a menu driven banner ads displayed with banner ads as submenu items.

18. The method for storing, retrieving and selecting mobile app ads in claim 10 further comprising the steps of providing banner ads to display stacked by frame in a 3D perspective rendering.

19. The method for storing, retrieving and selecting mobile app ads in claim 10 further comprising the steps of providing the banner ads to display stacked by frame in a 3D rendering.

20. A computer program residing in computer-readable medium for storing, retrieving and selecting mobile app ads on a mobile device further comprising the steps of:
having a mobile device with operatively connected display screen and at least one wireless connection protocol,
device providing a resident software environment with programmable display services and user specific mobile app display area controls,
registering at least one app with the ad service,
downloading at least one mobile app,
opening at least one channel of the wireless protocol to an ad server, and
receiving a plurality of ads from the ad server
whereby the ads received from the ad server can be displayed in a pre-set mobile app ad display area through the app users interactive use of mobile display controls in the app during app execution.
